(19) United States
(12) Patent Application Publication
(10) Pub. No.: US 2007/0193030 A1
(43) Pub. Date: Aug. 23, 2007

(54) NET FORMED GEAR MEMBER AND METHOD OF MANUFACTURE

(75) Inventors: Young Sik Kim, Canton, MI (US); Fumi K. Hida, Inazawa (JP)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/619,339

(22) Filed: Jan. 3, 2007

Related U.S. Application Data
(60) Provisional application No. 60/774,574, filed on Feb. 17, 2006.

(51) Int. Cl. B23P 15/14; B21K 1/30; F16H 37/12

(52) U.S. Cl. 29/893; 29/893.3; 74/52

(57) ABSTRACT

A gear member for an automatically shiftable vehicular transmission is provided having a gear body with a generally cylindrical outer surface having a plurality of radially outwardly extending gear teeth formed thereon. An inner surface is generally coaxially disposed with respect to the generally cylindrical outer surface and extends for at least a portion of the gear body. Additionally, a plurality of radially inwardly extending splines is formed on at least a portion of the inner surface. At least one of the plurality of radially outwardly extending gear teeth and the plurality of radially inwardly extending splines are cold extruded. A method of forming the gear member is also provided including forming a generally tubular blank by reverse extrusion of a generally cylindrical slug. Subsequently, a plurality gear teeth are formed on at least a portion of the generally tubular blank by cold extrusion to form the gear member.

### CROSS-REFERENCE TO RELATED APPLICATIONS

This application claims priority to U.S. Provisional Patent Application No. 60774574 filed on Feb. 17, 2006.

### TECHNICAL FIELD

The present invention relates to a net formed input sun gear member for an automatically shiftable vehicular transmission and a method of manufacturing same.

### BACKGROUND OF THE INVENTION

Gear members, which are typically utilized to transmit torque from one rotating shaft to another by utilizing meshingly engaged gear teeth, are well known. A plurality of interconnected gear members is known in the art as a gearset. A typical planetary gearset includes a sun gear member, a plurality of planet, or pinion, gear members supported by a carrier member, and an internal ring gear member.

Automatically shiftable vehicular transmissions typically include at least one planetary gearset within which the sun gear member is usually connected to and rotated by a drive or input shaft. The outer periphery or surface of the sun gear member includes a plurality of gear teeth formed thereon. Each of the sun gear teeth includes mating surfaces that meshingly engage with corresponding mating surfaces on respective gear teeth of a plurality of pinion gear members. The gear teeth of the pinion gear members also meshingly engage the gear teeth on the inner surface of the internal ring gear member.

During the operation of the planetary gearsets within the transmission, the sun gear member is meshingly engaged with the pinion gear members and operates to transmit high levels of torque thereto. As a result, the gear teeth of the sun gear member are exposed to heavy periodic or cyclic loading conditions. The number of times the load is applied to each sun gear tooth during a single revolution of the sun gear member is proportional to the number of pinion gear members in the planetary gearset. This repeated loading may result in fatigue and wear of the gear teeth mating surfaces of the sun gear member.

In a typical transmission utilizing a planetary gearset, the sun gear member is not rigidly mounted on the drive shaft, but is connected via a set of internal splines that engage with a corresponding or complementary set of external splines on the drive shaft. The splines allow the sun gear member to “float” i.e., to make small movements, in a radial direction while transmitting torque. These radial movements help to re-distribute the torque evenly among the pinion gear members, thereby increasing the overall torque capacity of the gearset. Because of this floating connection, the sun and pinion gear members occasionally experience dynamic loads in addition to the transmitted torque load. Typical processes used in manufacturing gear members may include hobbing, cutting, shaving, burnishing, grinding, lapping, followed by a thermo-chemical treatment, such as carburization.

### SUMMARY OF THE INVENTION

A net formed gear member is provided having a gear body with a generally cylindrical outer surface with a plurality of radially outwardly extending gear teeth formed thereon. An inner surface is generally coaxially disposed with respect to the generally cylindrical outer surface. The inner surface extends for at least a portion of the gear body. A plurality of radially inwardly extending splines are formed on at least a portion of the inner surface. At least one of the plurality of radially outwardly extending gear teeth and at least one of the plurality of radially inwardly extending splines are cold extruded.

The gear member may further include a plurality of radially outwardly extending splines formed on at least a portion of the generally cylindrical outer surface. The plurality of radially outwardly extending splines may be disposed axially adjacent to the plurality of radially outwardly extending gear teeth. The radially outwardly extending teeth may be helical in form and the gear body may be formed from steel, such that the gear member is sufficiently configured for use as an input sun gear within an automatically shiftable vehicular transmission. The gear body may define at least one hole operable to communicate fluid between the inner surface and the generally cylindrical outer surface. In a preferred embodiment the gear member will be heat treated.

Also provided is a method of forming a gear member. The method includes forming a generally tubular blank by reverse extrusion of a generally cylindrical slug. The generally tubular blank has an inner surface and an outer surface. Subsequently, a plurality of radially outwardly extending gear teeth are formed on at least a portion of the outer surface by cold extrusion to form the gear member.

The method may further include annealing the generally tubular blank prior to forming the plurality of radially outwardly extending gear teeth to reduce internal stresses within the generally tubular blank. Additionally, a plurality of radially inwardly extending splines may be formed on at least a portion of the inner surface by cold extrusion. The method may also include coating the generally cylindrical slug with a lubricant prior to forming the generally tubular blank. Similarly, the generally tubular blank may be coated with lubricant prior to forming the plurality of radially outwardly extending gear teeth. Finally, the gear member may be heat treated to increase the hardness thereof.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective view of a net formed input sun gear member for an automatically shiftable vehicular transmission consistent with the present invention and formed by the method of the present invention;

FIG. 2a is a cross sectional side view of a slug used to create the net formed input sun gear member of FIG. 1;

FIG. 2b is a cross sectional side view of a gear blank formed from the slug of FIG. 2a by a reverse or backward extrusion process;

FIG. 2c is a cross sectional side view of the gear blank of FIG. 2b following removal of the web formed during the backward extrusion process;

FIG. 2d is a cross sectional side view of the net formed input sun gear member of FIG. 1 following the formation, from the blank of FIG. 2c, of a plurality of radially outwardly extending gear teeth and a plurality of radially inwardly extending splines;

FIG. 2e is a cross sectional side view of the net formed input sun gear member of FIG. 2d following contouring; and

FIG. 2f is a cross sectional side view of the net formed input sun gear member of FIG. 2e following formation of a plurality of radially outwardly extending splines and a plurality of openings or holes.

### DESCRIPTION OF THE PREFERRED EMBODIMENTS

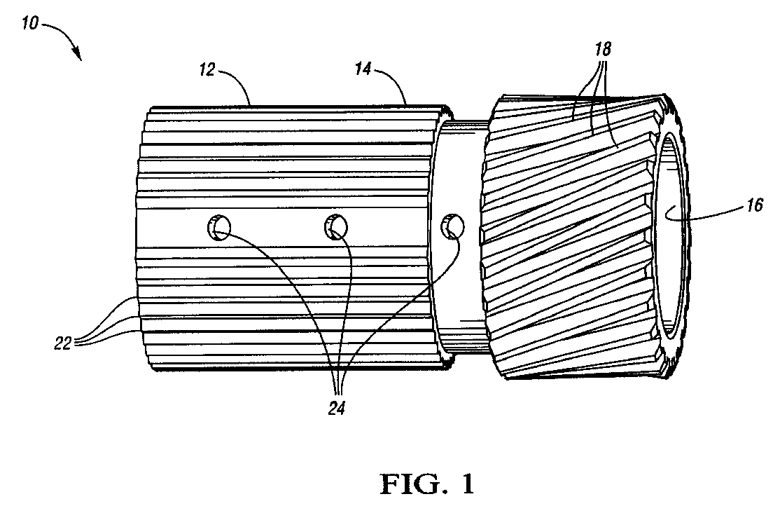

Referring to the drawings wherein like reference numbers represents like or a similar component throughout the several views, there is shown in FIG. 1 a gear member generally indicated at 10. The gear member 10 includes a gear body 12 having a generally cylindrical stepped outer surface 14 and a generally cylindrical stepped inner surface 16. In the preferred embodiment, the gear member 10 is configured to be used as an input sun gear member for an automatically shiftable vehicular transmission. However, it should be appreciated that the gear member 10 of the present invention may be used within a variety of applications without changing the inventive concept.

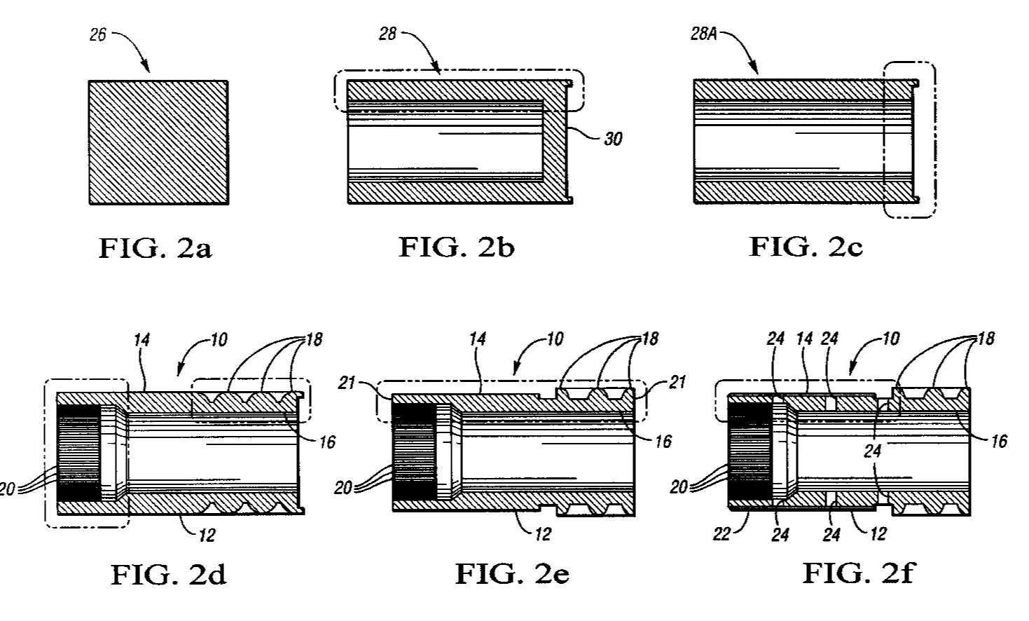

A plurality of generally radially extending gear teeth 18 extend outwardly from the outer surface 14. The gear teeth 18 are sufficiently configured to meshingly engage another gear member, such as pinion gear members within a planetary gearset, to transfer rotational torque thereto. The gear teeth 18 are preferably helical in form; however, those skilled in the art will recognize that other forms of gear teeth may be employed, such as a spur gear teeth, while remaining within the scope of that which is claimed. The gear teeth 18 of the present invention are characterized as being “net formed”, that is, the gear teeth 18 require little or no machining operations, such as hobbing, cutting, honing, etc., to either form or finish the gear teeth 18. The method of forming the gear teeth 18 will be described in greater detail hereinbelow with reference to FIG. 2d.

A plurality of generally radially extending splines 20, shown in FIGS. 2d through 2f, extend generally inward from the inner surface 16 at an end of the gear body 12 opposite the gear teeth 18. The splines 20 extend axially for at least a portion of the inner surface 16. The splines 20 are sufficiently configured to receive an input shaft, not shown, having a complementary splined portion formed thereon. The splines 20 of the present invention are characterized as being net formed. The method of forming the splines 20 will be described in greater detail hereinbelow with reference to FIG. 2d.

A plurality of generally radially extending splines 22 extend generally outward from the outer surface 14 at an end of the gear body 12 opposite the gear teeth 18. The splines 22 extend axially for at least a portion of the outer surface 14. Additionally, the gear body 12 defines a plurality of openings or holes 24 operable to allow the communication of fluid between the outer surface 14 and the inner surface 16 of the gear body 12, thereby providing a measure of lubrication between the splines 20 and 22.

The present invention also provides a method of manufacturing the gear member 10 described hereinabove. FIGS. 2a through 2f depict various steps of the preferred method with the portions modified in accordance with the present invention are generally delineated with phantom lines in FIGS. 2b through 2f. FIG. 2a illustrates a slug 26 that is preferably cut from an annealed steel bar formed from a steel alloy consistent with the desired metallurgy of the gear member 10 such as, for example, AISI 4620. The slug 26 is preferably machined such that the weight and dimensions of the slug 26 are maintained within acceptable tolerances. The slug 26 is coated with a lubricant, such as a phosphate coating, to allow smooth flow of metal during the forming process of FIG. 2b. The slug 26 is placed on a forming press and reverse or backward extruded to form a gear blank 28, shown in FIG. 2b. Those skilled in the art will recognize that during the backward extrusion process, the slug 26 is placed within a die and a pin will subsequently exert a large amount of axial force against the slug 26 such that metal within the slug 26 will flow around the pin and against the die to form the gear blank 28. This backward extrusion process produces compact grain flow within the gear blank 28, thereby increasing the material strength. The gear blank 28 is generally tubular in shape having one end closed by a web portion 30. Turning to FIG. 2c, the gear blank 28 is placed on a press to pierce out or otherwise detach the web portion 30 to form the gear blank 28A. The gear blank 28A is then annealed to relieve residual internal stresses created during the backward extrusion process of FIG. 2b and to prepare the gear blank 28A for additional cold working processes. Additionally, the gear blank 28A may be coated with a lubricant, such as phosphate, to allow the smooth flow of metal during the forming process of FIG. 2d.

Referring now to FIG. 2d, there is shown the gear member 10 formed from the gear blank 28A by cold extrusion. During this forming process, the gear teeth 18 are formed on the outer surface 14 of the gear body 12, while the splines 20 are formed on the inner surface 16 of the gear body 12. The cold extrusion process forms the gear teeth 18 and the splines 20 with a net formed characteristic such that little or no finish machining, such as honing, burnishing, grinding, or lapping, is required to provide the gear teeth 18 and splines 20 with a finished tooth profile and surface finish. Additionally, the compact grain flow near the roots of the gear teeth 18 and splines 20 as a result of the mechanical cold working of the cold extrusion process will tend to increase the strength of the gear teeth 18 and splines 20.

As shown in FIG. 2e, the outer surface 14 of the gear body 12 is contoured or configured as desired. The gear body 12 may be contoured using any process known in the art, such as grinding, turning, etc. Additionally, the ends 21 of the gear body 12 are squared to the final length of the gear body 12. Following contouring, the splines 22, as shown in FIG. 2f, are formed on the outer surface 14 of the gear body 12. The splines 22, in the preferred embodiment are formed by broaching. However, those skilled in the art will recognize other methods of forming splines 22 while remaining within the scope of that which is claimed. Additionally, as shown in FIG. 2f, the holes 24 are formed within the gear body 12 by drilling or another hole forming process known in the art. In the preferred embodiment, the gear member 10 then is heat treated using a carbonitride process producing a case depth of between 0.30 and 0.43 mm and a core hardness between 32 and 44 on the Rockwell C scale.

By forming the gear teeth 18 and the splines 20 with a net forming process such as cold extrusion, the torque carrying capacity of the gear member 10 may increase due to improved grain flow within the metal forming the gear teeth 18 and splines 20. Additionally, residual cutting tool marks or asperities, as a result of cutting and finish machining operations, may be eliminated thereby reducing stress raisers within the gear teeth 18 and splines 20.

While the best modes for carrying out the invention have been described in detail, those familiar with the art to which this invention relates will recognize various alternative designs and embodiments for practicing the invention within the scope of the appended claims.

1. A net formed gear member comprising:
a gear body having a generally cylindrical outer surface with a plurality of radially outwardly extending gear teeth formed thereon;
an inner surface generally coaxially disposed with respect to said generally cylindrical outer surface and wherein said inner surface extends for at least a portion of said gear body;
a plurality of radially inwardly extending splines formed on at least a portion of said inner surface; and
wherein at least one of said plurality of radially outwardly extending gear teeth and at least one of said plurality of radially inwardly extending splines are cold extruded, thereby reducing the machining steps required to produce the net formed gear member.

2. The gear member of claim 1, further comprising:
a plurality of radially outwardly extending splines formed on at least a portion of said generally cylindrical outer surface axially adjacent said plurality of radially outwardly extending gear teeth.

3. The gear member of claim 1, wherein said outwardly extending teeth are helical in form and said gear body is formed from steel and sufficiently configured for use as an input sun gear for an automatically shiftable vehicular transmission.

4. The gear member of claim 1, wherein said gear body defines at least one hole operable to communicate fluid between said inner surface and said generally cylindrical outer surface.

5. The gear member of claim 1, wherein said gear body is heat treated such that said gear body has a case depth and said gear body has a core hardness between 32 and 44 Rockwell C.

6. The gear member of claim 2, wherein said plurality of radially outwardly extending splines are broached.

7. A method of forming a gear member comprising:
forming a generally tubular blank by reverse extrusion of a generally cylindrical slug, wherein said generally tubular blank has an inner surface and an outer surface; and
forming a plurality of radially outwardly extending gear teeth on at least a portion of said outer surface by cold extrusion to form the gear member.

8. The method of claim 7, further comprising:
annealing said generally tubular blank prior to forming said plurality of radially outwardly extending gear teeth.

9. The method of claim 7, further comprising:
forming a plurality of radially inwardly extending splines on at least a portion of said inner surface by cold extrusion.

10. The method of claim 7, further comprising:
coating said generally cylindrical slug with a lubricant prior to forming said generally tubular blank.

11. The method of claim 7, further comprising:
coating said generally tubular blank with lubricant prior to forming said plurality of radially outwardly extending gear teeth.

12. The method of claim 7, further comprising:
forming a plurality of radially outwardly extending splines on at least a portion of said outer surface.

13. The method of claim 7, further comprising:
forming at least one hole operable to communicate fluid between said inner surface and said outer surface.

14. The method of claim 12 further comprising:
contouring said outer surface prior to forming said plurality of radially outwardly extending splines.

15. The method of claim 7 further comprising:
heat treating at least a portion of the gear member.

16. A method of forming an input sun gear member for an automatically shiftable vehicular transmission, the method comprising:
forming a generally tubular blank by reverse extrusion of a generally cylindrical slug, wherein said generally tubular blank has an inner surface and an outer surface;
annealing said generally tubular blank;
forming a plurality of radially inwardly extending splines on at least a portion of said inner surface by cold extrusion; and
forming a plurality of radially outwardly extending gear teeth on at least a portion of said outer surface by cold extrusion to form the input sun gear member.

17. The method of claim 16, further comprising:
coating said generally cylindrical slug with a phosphate based coating prior to forming said generally tubular blank.

18. The method of claim 16, further comprising:
coating said generally tubular blank with a phosphate based coating prior to forming said plurality of radially outwardly extending gear teeth.

19. The method of claim 16, further comprising:
forming a plurality of radially outwardly extending splines on at least a portion of said outer surface by broaching.

20. The method of claim 8 further comprising:
heat treating at least a portion of the input sun gear member.
